(19) United States
(12) Patent Application Publication
(10) Pub. No.: US 2024/0120504 A1
(43) Pub. Date: Apr. 11, 2024

(54) ELECTROCHEMICAL CATALYSTS FOR FUEL CELLS AND METHODS OF MAKING AND USING THE SAME

(71) Applicant: Kansas State University Research Foundation, Manhattan, KS (US)

(72) Inventors: Jun Li, Manhattan, KS (US); Archana Sekar, Manhattan, KS (US)

(21) Appl. No.: 18/476,651

(22) Filed: Sep. 28, 2023

Related U.S. Application Data
(60) Provisional application No. 63/377,916, filed on Sep. 30, 2022.

(51) Int. Cl. H01M 4/92; H01M 4/88; H01M 4/90

(52) U.S. Cl. CPC H01M 4/926; H01M 4/8882; H01M 4/9016; H01M 4/921

(57) ABSTRACT

Methods of making and using an improved electrochemical catalyst are provided herein. Catalysts as described herein include a carbon-containing support at least partially coated with a transition metal oxide shell. Catalytic nanoparticles, such as platinum nanoparticles, ruthenium nanoparticles, and/or PtRu alloy nanoparticles, are dispersed in and/or on the shell. The catalysts exhibit enhanced long-term stability and electrochemical activity, particularly with respect to the oxidation of methanol. Microwave-assisted synthesis and thermal annealing steps make the process of producing these catalysts both efficient and more easily scalable. The resulting catalysts have a wide range of end uses in renewable energy applications, including various types of fuel cells.

### CROSS-REFERENCE TO RELATED APPLICATIONS

This patent application claims the priority benefit to U.S. Provisional Patent Application No. 63/377,916, filed Sep. 30, 2022, the contents of which are incorporated by reference herein.

### FEDERALLY SPONSORED RESEARCH/DEVELOPMENT PROGRAM

This invention was made with government support under Grant No. DE-EE0008440 awarded by the United States Department of Energy, and Grant No. CBET-1703263 awarded by the National Science Foundation. The United States government has certain rights in the invention.

### FIELD OF THE INVENTION

This invention relates to catalysts, particularly those including catalytic metal nanoparticles dispersed on a carbon-containing support, that can be used in a wide variety of electrochemical applications including fuel cells.

### BACKGROUND

Growing energy demand attracts the investigation of renewable energy conversion devices such as direct methanol fuel cells (DMFC). DMFCs are specific types of fuel cells that use liquid methanol as the fuel to react with oxygen (preferably from the air) to produce electricity while generating water and carbon dioxide as byproducts. Typically, oxidation of methanol at the anode is the rate limiting factor for DMFCs. Thus, electrocatalysts are required to achieve efficient conversion of methanol fuel to carbon dioxide and generate electricity. The current state-of-the-art commercial electrocatalysts for methanol oxidation include platinum ruthenium (PtRu) alloy nanoparticles supported on amorphous carbon nanoparticle supports. These catalysts, however, exhibit poor stability and are expensive to produce. Thus, a need exists for a highly active and stable electrocatalyst that is prepared via low-cost and rapid synthesis methods that can be effectively employed for the oxidation of methanol, particularly in fuel cells such as DMFCs. Such a catalyst would help reduce the overall cost and availability of such fuel cells, which would promote their further commercialization and widespread use.

### SUMMARY

In one aspect, the present technology involves an electrochemical catalyst suitable for use in fuel cell applications, the catalyst comprising a carbon-containing support; a transition metal oxide shell coated onto at least a surface of the carbon-containing support; and a plurality of discrete catalytic nanoparticles disposed in and/or on at least a portion of the transition metal oxide shell.

In one aspect, the present technology involves a method of making an electrochemical catalyst suitable for use in a fuel cell, the method comprising: (a) forming a first reaction mixture comprising a carbon-containing support material, a metal oxide or precursor thereto, and a first solvent; and (b) heating the first reaction mixture to a temperature of not more than about 300° C. to form transition metal oxide coated carbon-containing support particles; (c) forming a second reaction mixture comprising the transition metal oxide coated carbon-containing support particles, at least one catalytic metal or precursor thereto, and a second solvent; and (d) heating the second reaction mixture to a temperature of at least 100° C. to provide particles of an electrochemical catalyst.

In one aspect, the present technology involves a fuel cell comprising: an anode; a cathode; and at least one fuel cell electrolyte disposed between the anode and the cathode, wherein at least one of the cathode, the anode, and the electrolyte present a first surface at least partially coated with a first catalyst layer, wherein the first catalyst layer comprises electrochemical catalyst particles comprising a carbon-containing support at least partially coated by a transition metal oxide layer and a plurality of discrete catalytic nanoparticles disposed in and/or on the metal oxide layer.

### BRIEF DESCRIPTION OF THE DRAWINGS

FIG. 1 is a schematic process flow diagram illustrating the main steps/zones of a process for making an electrochemical catalyst according to embodiments of the present technology;

FIG. 2 is a schematic cross-sectional exploded diagram of the main components of a fuel cell including, for example, an anode, a cathode, and an electrolyte assembly according to various embodiments of the present technology;

FIG. 3a is a transmission electron microscope (TEM) image of a titanium dioxide coated carbon support, wherein the carbon support is an oxygenated, nitrogen-doped carbon nanotube (ONCNT) and the coated support is prepared as described in Example 1;

FIG. 3b is a TEM image of another titanium dioxide coated carbon support, wherein the carbon support includes carbon black and the coated support is prepared as described in Example 1;

FIG. 3c is a TEM image of yet another titanium dioxide coated carbon support, wherein the carbon support includes Ketjen carbon black and the coated support is prepared as described in Example 1;

FIG. 4a is a TEM image of the support shown in FIG. 3a but further including a plurality of platinum-ruthenium (PtRu) nanoparticles (i.e., Catalyst 1) as described in Example 1;

FIG. 4b is a TEM image of the support shown in FIG. 3b but further including a plurality of platinum-ruthenium (PtRu) nanoparticles (i.e., Catalyst 2) as described in Example 1;

FIG. 4c is a TEM image of the support shown in FIG. 3c but further including a plurality of platinum-ruthenium (PtRu) nanoparticles (i.e., Catalyst 3) as described in Example 1;

FIG. 5a is a TEM image of a commercially available electrochemical catalyst including Pt and Ru on a carbon support (i.e., Comparative Catalyst I);

FIG. 5b is a TEM image of another commercially available electrochemical catalyst including Pt and Ru on a carbon support (i.e., Comparative Catalyst II);

FIG. 6a is a TEM image of a tin oxide coated carbon support (VULCAN® carbon black) prepared as described in Example 3;

FIG. 6b is a TEM image of another tin oxide coated carbon support (KETJENBLACK® carbon black) prepared as described in Example 3;

FIG. 6c is a TEM image of the tin oxide coated support shown in FIG. 6a, but a plurality of platinum-ruthenium (PtRu) nanoparticles (i.e., Catalyst 4); and

FIG. 6d is a TEM image of the tin oxide coated support shown in FIG. 6b, but a plurality of platinum-ruthenium (PtRu) nanoparticles (i.e., Catalyst 5).

### DETAILED DESCRIPTION

According to aspects of the present technology, an electrocatalyst for use in fuel cells—particularly direct methanol fuel cells (DMFC)—is provided herein. The electrocatalyst may help facilitate the oxidation of methanol in a DMFC but has application in other types of fuel cells as well. In some embodiments, the catalyst includes metal alloy nanoparticles deposited in and/or on a transition metal oxide coated carbon support. Efficient methods of making such a catalyst include a rapid microwave-assisted synthesis, which can help promote creation of an ultrathin layer (e.g., less than about 10 nm or so) of transition metal oxide on a carbon-containing support and permit deposition of discrete catalytic metal nanoparticles having well-controlled particle sizes (e.g., about 1 to 7 nm). The presence of the transition metal oxide layer may help provide a strong interaction with the catalyst nanoparticles, which promotes formation of catalytic metal alloys, but helps mitigate agglomeration of the nanoparticles during high-temperature annealing. Electrochemical catalysts (electrocatalysts) according to embodiments of the present invention exhibit excellent stability and improved electrocatalytic activity towards the oxidation of methanol and oxidative removal of carbon monoxide and other carbonaceous intermediates. This electrocatalyst has potential application in many renewable energy conversion devices, including hydrogen fuel cells and direct methanol fuel cells.

According to embodiments of the present technology, there is provided an electrochemical catalyst that comprises, consists of, or consists essentially of nanoparticles of a catalytic material, such as metal or metal alloy nanoparticles, deposited on an ultra-thin metal oxide shell coated on a carbon-containing support. In certain embodiments, the catalytic material comprises platinum or a platinum alloy, such as a platinum ruthenium (PtRu) alloy. Each of the aspects of the catalyst, as well as methods for making and using such catalysts, will be discussed in further detail below.

The carbon-containing support of the catalysts described herein can be formed from any suitable carbon-containing material. In some cases, the support may comprise at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95 weight percent carbon and/or not more than about 99, not more than about 97, not more than about 95, not more than about 90, or not more than 85 weight percent carbon, based on the total weight of the support. Additionally, the support may include at least about 1, at least about 3, at least about 5, at least about 10, or at least about 15 and/or not more than about 45, not more than about 35, not more than about 25, not more than about 20, not more than about 15, or not more than about 10 weight percent of components other than carbon. In some cases, the support may include at least about 97, at least about 98, or at least about 99 weight percent carbon, or may include only trace (e.g., less than 0.5, less than 0.25, less than 0.10 weight percent) amounts of components other than carbon, based on the total weight of the support.

The carbon-containing support can be in any suitable form. In some embodiments, the carbon-containing support may comprise a plurality of carbon particles, such as, for example, carbon black. When the carbon-containing support comprises particles, the particles can have an average particle diameter of at least about 5, at least about 10, at least about 15, at least about 20, at least about 25, at least about 30, at least about 35, at least about 40, at least about 45, or at least about 50 nanometers (nm) and/or not more than 200, not more than 175, not more than 150, not more than about 120, not more than about 110, not more than about 100, not more than about 90, not more than about 85, not more than about 80, not more than about 75, or not more than about 70 nm in at least one of the dimensions, measured by transmission electron microscopy (TEM). In some cases, the particles can be substantially spherical, while in other cases, the particles can be irregular in shape or in form of long one-dimensional fibers or two-dimensional flakes.

Specific examples of suitable carbon particle supports include, but are not limited to, graphene, and various types of amorphous carbon particles. The carbon particles (or carbon black particles) can be nanoparticles and may have an average particle size of at least about 5, at least about 10, at least about 15, at least about 20, or at least about 25 nm and/or not more than about 250, not more than about 225, not more than about 200, not more than about 175, not more than about 150, not more than about 125, or not more than about 100 nm. The carbon black particles may comprise amorphous carbon particles with mixed sp2 and sp3 chemical structures. Examples of suitable carbon blacks can include, but are not limited to, VULCAN® carbon black (commercially available from Cabot Corporation in Boston, Massachusetts), KETJENBLACK® carbon black (commercially available from Nouryon Functional Chemicals in Amsterdam, The Netherlands), and SUPER-P carbon black (commercially available from Fischer Scientific in Waltham, Massachusetts).

In some embodiments, the carbon-containing support can comprise carbon nanotubes (CNT), including, for example, carbon nanotube (CNT) fiber material. For example, in some cases, the carbon-containing support can include a CNT fiber material that resembles a plurality of cones stacked together to form long fibers. In some cases, the CNT fiber material can have an average diameter of at least about 10, at least about 15, at least about 20, or at least about 25 nm and/or not more than about 200, not more than 175, not more than 150, not more than 125, not more than 100, not more than about 75, not more than about 70, not more than about 65, not more than about 60, not more than about 55, or not more than about 50 nm, and it can have a length of at least about 0.5, at least about 1, at least about 1.5, at least about 2, at least about 5, or at least about 10 microns and/or not more than about 20, not more than about 17, not more than about 15, not more than about 12, not more than about 10, or not more than about 8 microns, measured by transmission electron microscopy (TEM).

Regardless of its specific form, the carbon-containing support can have a BET specific surface area (SSA) of at least about 10, at least about 20, at least about 30, at least about 40, at least about 50, at least about 60, at least about 75, at least about 100, at least about 200, at least about 500, at least about 750, at least about 1000, at least about 1250, at least about 1500, at least about 1750, or at least about 2000 m²/g and/or not more than about 4000, not more than about 3500, not more than about 3000, not more than about 2500, not more than about 2000, not more than about 1750, not more than about 1500, not more than about 1250, not more than about 1000, not more than about 750, not more than about 500, not more than about 300, or not more than about 200 m²/g.

According to some embodiments, at least a portion of the carbon in the carbon-containing support can be functionalized. For example, in some cases, the carbon-containing support (whether in the form of particles or CNTs) may comprise oxygenated (i.e., oxygen functionalized) carbon. Such oxygenated carbon can be formed by treatment with a strong acid solution, a strong base solution, or heat treatment with the mixture of carbon and solid strong bases. Although not wishing to be bound by theory, oxygenation of the carbon-containing support may impart some hydrophilicity to the typically hydrophobic material. As a result, the oxygenated carbon-containing supports can be more uniformly dispersed in aqueous solutions for subsequent reactions. This can help promote uniform metal deposition along the surface of the catalyst in later steps of the process.

Additionally, or in the alternative, at least a portion of the carbon-containing support may be doped to include one or more atoms of another chemical element such as, for example, nitrogen. When the carbon-containing support includes doped carbon material, it can have a doping level of at least about 1, at least about 2, at least about 3, at least about 4, or at least about 5 atom percent and/or not more than about 30, not more than about 27, not more than about 25, not more than about 22, not more than about 17, not more than about 15, not more than about 12, not more than about 10, or not more than about 6 atom percent, measured throughout the entire volume of material. In some embodiments, the carbon material in the carbon-containing support (e.g., carbon particles or CNTs) can be an oxygen-functionalized, nitrogen-doped carbon material. The loss tangent value of the carbon-containing support can be at least about 0.50, at least about 0.60, at least about 0.70, at least about 0.75, at least about 0.80, at least about 0.90, at least about 0.95, at least about 0.97, or at least about 0.99 and/or not more than about 1.4, not more than about 1.3, not more than about 1.2, or not more than about 1.1.

In some embodiments, at least a portion of the carbon-containing support may be crystalline and/or at least a portion of the carbon-containing support may be amorphous. In some cases, the crystalline structure of the carbon-containing support changes during processing and, as a result, the final catalyst may have a different crystalline structure than the carbon-based material used as a starting material. The carbon-containing support may include graphitic layers or portions and, in some cases, may comprise a CNT material with a high density of broken graphitic edges at the surface of the CNT. The presence of such structures, as well as areas of crystalline and amorphous material, would be determined by transmission electron microscopy (TEM).

According to some embodiments, the electrocatalyst can further include an ultra-thin metal oxide shell coated onto at least a portion of the carbon-containing support. The metal oxide shell or layer can be coated onto at least about 40, at least about 50, at least about 60, at least about 70, at least about 80, at least about 85, at least about 90, at least about 95, at least about 97, or at least about 99 percent of the total surface area of the carbon-containing support. In some cases, the metal oxide shell can cover the entire (100 percent) of the surface area of the carbon-containing support.

Although not wishing to be bound by theory, it is believed that the metal oxide shell helps to anchor the metal or metal alloy nanoparticles to the carbon-containing support so that the nanoparticles retain a relatively small size (e.g., less than about 10 nm in diameter), even after annealing of the catalyst as described in further detail below. Additionally, or in the alternative, the presence of the metal oxide shell may help the catalyst remain stable during electrochemical operation within a fuel cell, thereby imparting enhanced chemical and mechanical stability to the catalyst. Furthermore, it is believed that the abundant —OH species provided by the metal oxide shell may modify the d-band vacancy in the platinum valence orbital, thereby weakening the platinum-carbon monoxide (Pt—CO) binding during the methanol oxidation reaction (MOR), which may also help to increase the uniformity of dispersion of the catalytic nanoparticles on the carbon-containing support and/or improve corrosion resistance of an electrode formed with the catalyst in a fuel cell or other application. The metal oxide shell may protect at least a portion of the carbon-containing support.

The metal oxide shell can include any type of metal oxide that is stable in acidic electrolytes solutions commonly used in fuel cells. Particularly suitable metal oxides include, for example, transition metal oxides. As used herein, the term “transition metal” refers to a metal in the central block of the periodic table in Groups IB, IIB, and IVB through VIIB (or Groups 4-12). Thus, a “transition metal oxide” is the oxide form of one or more transition metals. Examples of suitable transition metal oxides include, but are not limited to, titanium dioxide (TiO₂), tin (IV) oxide (SnO₂), ruthenium (IV) oxide (RuO₂), cerium (IV) oxide (CeO₂), and combinations thereof. Metal oxides with other oxidation states of these transition metals are also possible.

According to some embodiments, the metal oxide shell (or transition metal oxide shell) can have an average thickness (measured by TEM at 5 spaced-apart locations on the coated catalyst) of at least about 1, at least about 2, at least about 2.5, at least about 3, at least about 4, at least about 5, at least about 6, at least about 7, or at least about 8 nm and/or not more than about 15, not more than about 12, not more than about 10, not more than about 8, not more than about 7, or not more than about 5 nm. In some cases, the metal oxide shell can comprise at least about 5, at least about 10, at least about 15, or at least about 20 weight percent and/or not more than about 45, not more than about 40, not more than about 35, not more than about 30, or not more than about 25 weight percent of the catalyst itself, based on the total weight of all components making up the catalyst.

The metal oxide shell may include amorphous metal oxide, crystalline metal oxide, or both amorphous and crystalline metal oxide. When the metal oxide shell includes crystalline metal oxide, it may be present in an amount of at least about 1, at least about 5, at least about 10, at least about 15, or at least about 20 weight percent and/or not more than about 45, not more than about 40, not more than about 35, not more than about 30, not more than about 25, or not more than about 20 percent, based on the total weight of metal oxide present on the catalyst. Alternatively, or in addition, the metal oxide shell can include at least about 55, at least about 60, at least about 75, at least about 80, at least about 85, at least about 90, or at least about 95 weight percent of amorphous metal oxide, based on the total weight of metal oxide in the catalyst.

In some cases, the crystalline metal oxide may be in the form of very small crystals dispersed within the amorphous metal oxide such as, for example, nanocrystals of metal oxide embedded or dispersed in a continuous amorphous metal oxide layer. Such nanocrystals can have an average size of at least about 1, at least about 2, at least about 3, or at least about 4 nm and/or not more than about 15, not more than about 12, nor more than about 10, not more than about 8, or not more than about 6 nm, measured by TEM imaging. In some cases, the metal oxide can be a hydrogenated metal oxide such as, for example, hydrogenated titanium dioxide. As discussed in detail below, the metal oxide shell may initially be applied as an amorphous layer, and portions of it may form nanocrystalline regions as part of the processing steps.

The electrochemical catalysts described herein further comprise a plurality of catalytic nanoparticles disposed in and/or on at least a portion of the metal oxide shell coated onto the carbon-containing support. More specifically, the metal oxide shell on the surface of the carbon-containing support provides a surface and the catalytic nanoparticles may be present as a plurality of separate, discrete particles dispersed generally uniformly over the surface of the metal oxide coating and deposited on and/or in the metal oxide layer.

The particles may have an average particle size of at least about 1, at least about 1.5, at least about 2, at least about 2.5, at least about 3, or at least about 3.1 nm and/or not more than about 10, not more than about 8, not more than about 6, not more than about 5.5, not more than about 5, not more than about 4.5, not more than about 4, or not more than about 3.8 nm, measured by TEM at 5 spaced-apart locations. The standard deviation of the average particle size of the nanoparticles can be at least about 0.01, at least about 0.05, at least about 0.10, at least about 0.5, at least about 1, at least about 1.5, or at least about 2 nm and/or not more than about 1.5, not more than about 1.4, not more than about 1.3, not more than about 1.25, not more than about 1, not more than about 0.75, not more than about 0.50, or not more than about 0.25 nm. In some cases, at least a portion of the catalytic nanoparticles may comprise crystalline nanoparticles and can be formed, for example, during the annealing of the electrocatalyst as described in further detail below.

The catalytic nanoparticles can comprise nanoparticles of a metal or metal alloy and may be present in an amount of at least about 5, at least about 7, at least about 10, at least about 12, at least about 15, at least about 17, at least about 20, at least about 22, at least about 25, at least about 27, or at least about 30 weight percent and/or not more than about 55, not more than about 50, not more than about 47, not more than about 45, not more than about 42, not more than about 40, not more than about 37, not more than about 35, or not more than about 32 weight percent, based on the total weight of catalyst, measured using TGA. The thermogravimetric analysis (TGA) includes measuring the mass loss of catalyst and a series of control samples (such as bare carbon supports, metal oxide-coated carbon supports, metal nanoparticles without supports, etc.) in ambient air atmosphere or pure nitrogen gas as the temperature is raised at a steady rate (5-40° C./min) from the room temperature to 900° C.

The metal or metal alloy may comprise any suitable catalytic metals, such as, for example Group VIII (or Group 8-10) metals such as platinum (Pt), ruthenium (Ru), palladium (Pd), rhodium (Rh), cobalt (Co), molybdenum (Mo), copper (Cu), and combinations thereof. In some cases, the catalytic particles include a single metal, while, in other cases, the particles comprise a metal alloy. Particles of a metal alloy may include an alloy of at least 2, at least 3, at least 4 or more metals. Metal alloy particles may include, for example, platinum alloys, ruthenium alloys, or combinations thereof. When present, the metal alloy may be added during preparation of the catalyst, or it may be formed in situ during catalyst preparation.

According to some embodiments, the catalytic nanoparticles on the electrocatalyst include both singular metal and metal alloy catalyst particles. For example, the catalyst may include ruthenium nanoparticles, platinum nanoparticles, and particles of platinum-ruthenium (Pt—Ru) alloy. When the particles include a Pt—Ru alloy, the ratio of Pt to Ru can be at least about 0.25:1, at least about 0.50:1, at least about 0.75:1, at least about 1:1, at least about 1.1:1, at least about 1.2:1, at least about 1.25:1, at least about 1.3:1, at least about 1.4:1, at least about 1.5:1, at least about 1.6:1, at least about 1.7:1, at least about 1.75:1, at least about 1.8:1, or at least about 1.9:1 and/or not more than about 5:1, not more than about 4:1, not more than about 3:1, not more than about 2.5:1, not more than about 2.25:1, not more than about 2:1, not more than about 1.75:1, not more than about 1.65:1, or not more than about 1.5:1. The atomic percentages (and ratios) were determined by quantitative analyses of the spectra of X-ray Photoelectron Spectroscopy (XPS).

According to embodiments of the present technology, the electrocatalyst described herein can exhibit better electrocatalytic activity than identical catalysts without a metal oxide shell. For example, in some cases, electrochemical catalysts as described herein can exhibit a carbon monoxide (CO) onset potential that is at least about 0.10, at least about 0.20, or at least about 0.30 V and/or not more than about 0.65, not more than about 0.60, not more than about 0.50, or not more than about 0.40 V lower than the CO onset potential of an identical catalyst formed without the metal oxide shell. In some cases, the electrocatalyst formed as described herein can have a CO onset potential of not more than about 0.200, no more than about 0.195, not more than about 0.190, not more than about 0.185, or not more than about 0.175 V measured as described in Example 5, below. Lower CO onset potential correlates to lower CO oxidation potential, which translates to higher efficiency to reduce CO poisoning on Pt surface and lower levels of corrosion during use, particularly in fuel cell applications.

Additionally, or in the alternative, the electrocatalysts described herein can have an electrochemical active surface area (ECSA) greater than an identical catalyst formed without a metal oxide shell. For example, in some cases, the ECSA can be at least about 10, at least about 20, at least about 25, or at least about 30 percent and/or not more than about 60, not more than about 55, not more than about 50, not more than about 45, or not more than about 40 percent, or not more than 35 percent higher than the ESCA of an identical catalyst formed without the metal oxide shell. The catalyst can have an ESCA of at least 50, at least 55, at least 60, at least 65, at least 75, at least 85, at least 92, at least 95, at least 100, at least 110, at least 120, at least 130, or at least 132 m²/g, measured as described in Example 5.

The electrocatalysts described herein also exhibit an improved catalytic activity as compared to catalysts without a metal oxide shell. Such catalytic activity may be related to, for example, the forward peak current density (I_{f}) measured for a typical MOR cyclic voltametric (CV) curve as described in Example 6. In some cases, the electrocatalysts as described herein can have an I_{f} of at least about 13.5, at least about 14, at least about 14.5, at least about 15, at least about 15.5, at least about 16, at least about 16.5, at least about 17, at least about 17.5, or at least about 18 mA/cm²_{geo}. Additionally, or in the alternative, the electrocatalysts of the present technology can have a mass activity, calculated as described in Example 6, of at least about 350, at least about 400, at least about 450, at least about 475, or at least about 500 mA/mg of platinum (Pt) and/or not more than about 700, not more than about 650, not more than about 600, not more than about 550, or not more than about 525 mA/mg Pt.

Further, the electrocatalysts as described herein can have improved long-term stability, as measured by the drop in forward current (I_{f}) over 500 cyclic voltammetry (CV) cycles, measured as described in Example 6. In some cases, the drop in I_{f} over 500 CV cycles exhibited by the catalysts described herein can be not more than about 15, not more than about 12, not more than about 10, not more than about 8, not more than about 7, not more than about 5, or not more than about 4 percent. Smaller drops in If over a significant number of CV cycles (e.g., 500) indicates better stability (e.g., less breakdown) of the catalyst over time and use.

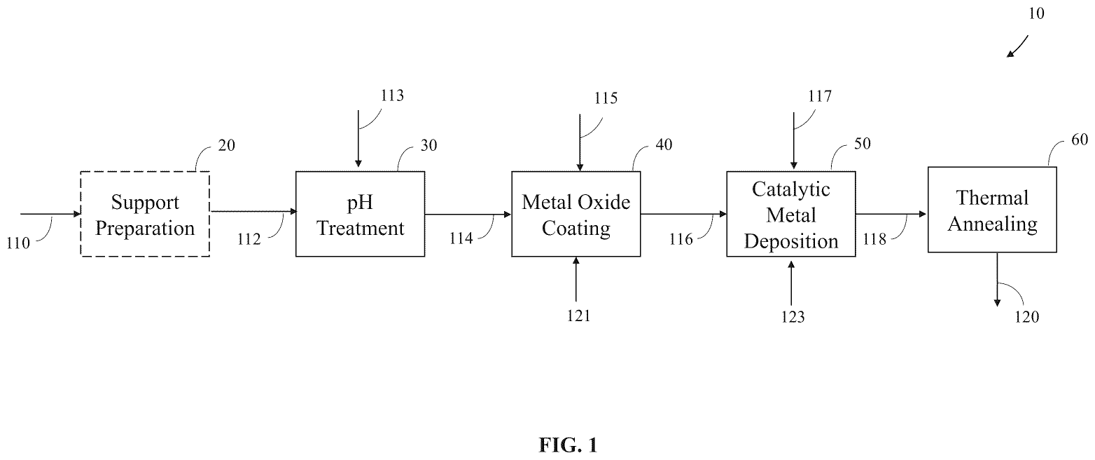

The present technology provides a method of making electrocatalyst that is several times faster than the conventional time-consuming and energy intensive deposition techniques. In fact, during formation of electrocatalysts as described herein, the metal oxide shell is not deposited onto the carbon-containing support via any of atomic layer deposition (ALD), chemical vapor deposition (CVD), or hydrothermal synthesis. Instead, according to embodiments of the present technology, the metal oxide layer can be deposited onto the carbon-containing support via a microwave-assisted heating step. As used herein, the term “microwave” refers to electromagnetic energy having a frequency of from about 300 MHz to 300 GHz. Specific details of the methods of making electrocatalysts described herein are provided below with regard to FIG. 1.

Turning now to FIG. 1, a schematic flow diagram of the major steps/zones in a process or facility for producing an electrocatalyst as described herein in accordance with various embodiments of the present technology is provided. As shown in FIG. 1, carbon-containing support material 110 can optionally be treated in a support preparation step or zone 20 and the resulting materials can be treated with at least one acid or base in a pH treatment step or zone 30 to provide an oxygenated carbon-containing support 114. The oxygenated support 114 may then be coated with a metal oxide coating in step or zone 40 to provide a metal oxide coated carbon-containing support in line 116. Thereafter, as shown in FIG. 1, the metal oxide coated support may then be treated add a catalytic metal thereon in a catalytic metal deposition step or zone 50, and the resulting material may then be thermally annealed in a thermal annealing step or zone 60 to provide an electrocatalyst material 120 as described herein. Details regarding these steps or zones and related process intermediates are provided below.

According to some embodiments, the method of making the electrocatalysts described herein and generally shown in FIG. 1 may be carried out on a pilot plant scale. That is, the total amount of catalyst produced from a given process or facility may be at least 50 pounds per month, calculated as a consecutive 30-day period. In some cases, the process or facility of making electrocatalysts according to the present technology can produce at least about 500, at least about 750, at least about 1000, at least about 2500, at least about 5000, or at least about 7500 pounds per month and/or not more than about 25,000, not more than about 20,000, not more than about 15,000, not more than about 10,000, or not more than about 7500 pounds per year.

Alternatively, the processes and facilities described herein may be carried out or may be commercial scale such that, for example, they provide at least about 1000, at least about 5000, at least about 10,000, at least about 20,000, at least about 25,000, at least about 50,000, at least about 75,000 or at least about 100,000 pounds of catalyst per month, calculated over a consecutive 30-day period. In some cases, the methods described herein can apply to a lab-scale production (e.g., less than about 250 pounds per month). However, in most cases, pilot-scale or commercial-scale production may be carried out. The methods described herein may be suitable for lab-scale production (i.e., less than 50 pounds per month, calculated as a consecutive 30-day period), but, in some cases, it may not be performed on a lab scale.

In some embodiments, at least a portion, or all, of the steps of the process for producing an electrocatalyst as described herein (and shown generally in FIG. 1) can be performed at a pressure at, near, or above atmospheric pressure. For example, one or more steps may be performed at a pressure of at least about 1, at least about 2, at least about 3, or at least about 5, at least about 10, at least about 15, at least about 20, or at least about 30 bar gauge. One or more other steps may be performed at a pressure at or near atmospheric. In some cases, few, if any, of the processing steps are performed under a vacuum, which is in contrast to many conventional methods of depositing nanoparticles onto carbon-containing supports, which are mainly performed at sub-atmospheric pressures. In some cases, less than about 10, less than about 5, or less than about 2 percent of the total process/facility 10 shown in FIG. 1 is carried out/operated at a pressure less than atmospheric pressure.

As shown in FIG. 1, the carbon-containing support material 110 can be any material comprising carbon suitable for use as a catalyst support. As discussed previously, the carbon-containing support material can comprise amorphous carbon materials such as amorphous carbon or carbon black, or it may include graphitic sp²-type carbon such as graphene and carbon nanotube (CNT) materials, or carbon nanofibers. Regardless of its specific structure, the carbon-containing support material 110 may optionally be introduced into a support preparation step or zone 20, wherein the material may be prepared for further processing. Such preparation steps may include, but are not limited to, washing, drying, and even doping the carbon-containing precursor (e.g., pristine carbon nanotubes) with one or more other types of atoms to provide a doped carbon-containing support as described previously. Any suitable methods for accomplishing these steps can be used including, but not limited to, chemical vapor deposition (CVD) (for the doping step). Some exemplary methods of carrying out various treatment steps for the carbon-containing support are also described in Example 1 below.

Referring again to FIG. 1, the carbon-containing support material (or treated carbon-containing support material when step/zone 20 is performed) 112 may then be introduced into pH treatment step or zone 30. In the pH treatment step/zone 30, at least a portion of the carbon-containing support material 112 introduced into the step/zone 30 can be treated with at least one acid or base, preferably a strong acid or base, introduced via line 113. Examples of strong acids include, but are not limited to, hydrochloric acid, nitric acid, sulfuric acid, phosphoric acid, and combinations thereof. The strength of the acid or acids used in this step can be, for example, at least 1, at least 2, at least 3, at least 4, at least 5, or at least 6 M acid and/or not more than about 10, not more than about 8, not more than about 6, or not more than about 5 M acid. In some cases, the acid used to treat the carbon-containing support material can be a mixture of two or more of the above acids, such as, for example, nitric and sulfuric acids. The acid may comprise an aqueous acid solution.

In some embodiments, the non-neutral pH stream in line 113 may comprise a strong base. The strong base in line 113 can comprise an aqueous solution and may have a concentration within one or more ranges above. Examples of suitable bases, include but are not limited to, sodium hydroxide and potassium hydroxide.

In the pH treatment step or zone 30, the carbon-containing material 112 may be contacted with the acid or base for a time period of at least about 2, at least about 4, at least about 6, at least about 8, or at least about 10 hours and/or not more than about 24, not more than about 22, not more than about 20, not more than about 18, not more than about 16, or not more than about 14 hours. During contact, the solution or mixture of acid or base and carbon-containing support material may be maintained at a temperature of at least about 80, at least about 90, at least about 100, at least about 110, or at least about 115° C. and/or not more than 140, not more than 135, not more than 130, or not more than 125° C. in a reflux setup. Once the treatment step is complete, the resulting oxygenated carbon-containing support may be washed with deionized water to achieve a neutral pH and then dried at a temperature of at least about 65, at least about 70, at least about 75, or at least about 80° C.

The oxygenated carbon-containing support exiting the pH treatment step/zone 30 in line 114 may then be subjected to/introduced into a metal oxide coating step/zone 40, as shown in FIG. 1. In the metal oxide coating step/zone 40, the acid- or base-treated (e.g., oxygenated) carbon-containing support in line 114 may be combined with a first solvent 121 and a metal oxide (or metal oxide precursor) 115 to form a first reaction mixture. The combining can be done according to any suitable method, such as stirring or ultrasonication, and it may be done over a period of at least about 10, at least about 15, at least about 20, or at least about 25 minutes and/or not more than about 60, not more than about 55, not more than about 50, not more than about 45, not more than about 40, or not more than about 35 minutes.

In some embodiments, the metal oxide added to the metal oxide coating step/zone 40 can comprise a metal oxide precursor. Such a precursor is at least one compound that, when subjected to the processing conditions of at least a portion of the step/zone 40 will provide a metal oxide. One example of a metal oxide precursor is titanium tetraisopropoxide (TTIP), which when added to the first reaction mixture described herein ultimately results in formation of a titanium dioxide shell on the surface of the carbon-containing support. Similarly, tin isopropoxide can be used to form a tin (IV) oxide shell on the surface of the carbon-containing support. Other suitable metal oxide precursors can be used. According to some embodiments, the weight ratio of metal oxide (or metal oxide precursor) to carbon-containing support in the first reaction mixture can be at least about 0.5:1, at least about 0.75:1, or at least about 0.95:1 and/or not more than 3:1, not more than 2:1, not more than 1.5:1, or not more than 1.2:1. In some cases, it can be about 1:1.

The solvent used to form the first reaction mixture can be any suitable solvent. In some embodiments, it can comprise, consist of, or consist essentially of water, at least one alcohol, and/or at least one glycol. In some cases, the alcohol and/or glycol can be a C₂ to C₁₂, a C₂ to C₁₀, or a C₂ to C₆ alcohol and/or glycol. As used herein, the term “Cₓ” refers to a compound including x number of carbon atoms per molecule, including any isomer thereof. Examples of solvents can include, but are not limited to, one or more of ethanol, propanol, iso-propanol, butanol, iso-butanol, water, ethylene glycol, and propylene glycol. When two or more solvents are used to form the first reaction mixture, they can be present in a volume ratio of at least about 1:1, at least about 2:1, or at least about 3:1 and/or not more than about 8:1, not more than about 6:1, not more than about 5:1, or not more than about 4:1. In some cases, the first solvent can comprise, consist essentially of, or consist of ethanol.

After the first reaction mixture is formed, it can be heated to a temperature of not more than about 300, not more than about 275, not more than about 250, not more than about 225, not more than about 200, not more than about 175, not more than about 170, not more than about 165, not more than about 160, not more than about 155, or not more than about 150° C. The first reaction mixture can be heated to a temperature of at least about 120, at least about 125, at least about 130, at least about 135, at least about 140, at least about 145, or at least about 150° C.

The heating of the first reaction mixture can be performed by any suitable method, but in some embodiments, at least a portion can be carried out using microwave energy. As used herein, the term “microwave energy” refers to energy having a frequency between about 300 MHz and 300 GHz. When microwave energy is used to heat the first reaction mixture, at least about 80, at least about 90, at least about 95, at least about 97, or at least about 99 percent of the total energy used to perform the heating can be from microwave energy. That is, less than about 20, less than about 10, less than about 5, less than about 2, or less than about 1 percent of the total energy used in this heating step comes from energy other than microwave energy. One example of a suitable microwave frequency is 2.45 GHz.

The heating of the first reaction mixture can be carried out for a period of time of at least about 1, at least about 1.5, at least about 2, at least about 2.5, at least about 3 minutes and/or not more than about 1 hour, not more than about 45, not more than about 40, not more than about 35, not more than about 30, not more than about 25, not more than about 20, not more than about 15, not more than about 10, or not more than about 8 minutes. As a result of the heating step, an amorphous metal oxide coating (or shell) can be formed on at least a portion of the outer surface of the carbon-containing support.

Referring again to FIG. 1, at least a portion of the metal oxide coated carbon-containing particles in line 116 may then be introduced into the catalytic metal deposition step or zone 50. Although shown as two separate zones in FIG. 1, it is possible that each of the metal oxide coating step 40 and the catalytic metal deposition step 50 can be carried out in a single vessel or reactor. In other cases, these steps 40 and 50 can be carried out in separate vessels or reactors.

In the catalytic metal deposition step or zone 50, a second reaction mixture is formed by combining the metal oxide coated carbon-containing supports with at least one metal (or metal precursor) in a second solvent. The second solvent can be the same or different than the first solvent and, in some cases, it may include one or more of the types and amounts of solvents described previously with respect to the first solvent. In some embodiments, the second solvent can include a mixture of two or more solvents as mentioned previously and may, for example, include ethylene glycol and water in a volume ratio of at least about 1:1, at least about 2:1, or at least about 3:1 and/or not more than about 8:1, not more than about 6:1, or not more than about 5:1. Other types and ratios of solvents as described herein are also suitable for use in the second reaction mixture.

In some embodiments, the second reaction mixture can comprise at least one metal. In other embodiments, the second reaction mixture can comprise at least one metal precursor. The second reaction mixture may only include one type of metal or metal precursor, or it may include two or more different types of metal or metal precursors. For example, it may only include platinum metal (or a precursor thereof), or it may include both platinum and ruthenium metals (or precursors thereof). Examples of metal precursors include, but are not limited to, halogenated metals of Group VIIB (Groups 8-10) of the Periodic Table. Specific examples include ruthenium chloride and potassium platinum chloride. In some embodiments, the metal or metal precursor can be in the form of a plurality of nanoparticles which can then be deposited onto the metal oxide support as described in further detail below.

Once formed, the second reaction mixture can then be heated in order to deposit a plurality of catalytic metal particles onto the surface of the metal oxide coated carbon-containing support. This heating step in the catalytic metal deposition step/zone 50 can be sufficient to increase the temperature of the second reaction mixture to at least about 100, at least about 125, at least about 150, at least about 175, at least about 180, at least about 185, at least about 190, or at least about 195° C. The temperature of the second reaction mixture may be not more than about 210, not more than about 205, not more than about 200, or not more than 195° C. The heating step can be carried out for a period of time of at least about 5, at least about 8, at least about 10, at least about 12, at least about 15, or at least about 17 minutes and/or not more than about 2 hours, not more than about 1 hour, not more than about 45 minutes, not more than about 30 minutes, or not more than about 25 minutes.

Similarly to the first heating step in the metal oxide coating step or zone 40, at least a portion of the heating performed as part of the catalytic metal deposition step or zone 50 can also be carried out using microwave energy. For example, at least about 80, at least about 90, at least about 95, at least about 97, or at least about 99 percent of the total energy used to carry out the heating step in the catalytic metal deposition step or zone 50 can be microwave energy. Conversely, in some cases, not more than about 20, not more than about 10, not more than about 5, not more than about 3, or not more than about 1 percent of the total energy used to carry out this heating step can be from energy other than microwave energy.

The resulting catalyst includes a plurality of discrete metal nanoparticles dispersed in and/or on the metal oxide shell covering at least a portion, or all, of the surface area of the carbon-containing support. Although not wishing to be bound by theory, it is believed that the materials used in forming the electrocatalysts described herein strongly absorb microwave energy, particularly relative to any solvents used to disperse the precursor compounds. As a result, the surface of the particles (e.g., carbon-containing support) heats up faster than the bulk solution when exposed to microwave energy. This may cause the metal and/or metal oxide to preferentially deposit on the surface of the carbon-containing support instead of forming nanoparticles dispersed within the solvent. As a result, the nanoparticles formed on the metal oxide surface can have an ultra-small particle size within one or more of the ranges described herein.

Referring again to shown in FIG. 1, this catalyst in line 118 can optionally be subjected to a thermal annealing step/zone 60, wherein the catalyst particles are heated for a time sufficient to, for example, alloy the metallic nanoparticles and crystallize at least a portion of the amorphous metal oxide shell. The annealing can be carried out at a temperature of at least about 300, at least about 310, at least about 325, at least about 350, at least about 360, at least about 375, at least about 380, at least about 390, at least about 395, or at least about 400° C. and/or not more than about 700, not more than about 650, not more than about 575, not more than about 550, not more than about 525, not more than about 500, not more than about 475, not more than about 450, not more than about 425, or not more than about 410° C., in a reducing or inert atmosphere to provide a crystalline electrochemical catalyst. The temperature of the annealing step/zone 60 may be controlled to minimize nanoparticle agglomeration.

Although not wishing to be bound by theory, it is believed that the thermal annealing zone/step 60 induces several changes in the catalyst. First, this step converts atoms of individual metals into metal alloys. For example, when Pt and Ru are applied to the catalyst in the metal deposition step/zone 50, the Pt and Ru atoms are formed into PtRu metal alloys in the annealing step/zone 60. Additionally, the annealing step/zone 60 may convert at least a portion of the amorphous metal oxide shell (e.g., TiO₂) into crystalline nanoparticles (e.g., anatase TiO₂) embedded in the continuous amorphous phase. Finally, the annealing step/zone 60 may produce hydrogenation defects (e.g., reducing some Ti⁴⁺ to Ti³⁺), which may serve as oxygen-vacant dopants.

The thermal annealing step 60 can be carried out for a period of time of at least about 20, at least about 30, at least about 45 minutes, at least about 1 hour, or at least about 1.5 hours and/or not more than about 5, not more than about 4.5, not more than about 4, not more than about 3.5, not more than about 3, or not more than about 2.5 hours. In some embodiments, the thermal annealing step or zone 60 may include a reducing atmosphere, wherein the reaction is carried out in the presence of at least one reducing agent. The reducing agent may be present in an amount of at least 0.5, at least about 1, at least about 1.5, at least about 2, at least about 2.5, or at least about 2.75 volume percent and/or not more than about 7, not more than about 6.5, not more than about 6, not more than about 5.5, not more than about 5, not more than about 4.5, not more than about 4, or not more than about 3.75 volume percent, with the balance being an inert gas such as argon, nitrogen, or combinations thereof. An example of a suitable reducing agent includes, but is not limited to, hydrogen. In some cases, the thermal annealing step can be carried out in an environment including, for example, 2 to 5 volume percent hydrogen and 95 to 98 volume percent argon and/or nitrogen.

Alternatively, the thermal annealing step can be carried out in an inert environment including at least about 99.5, at least about 99.7, or at least about 99.9 volume percent of at least one inert gas. Such an environment may comprise, for example, less than 0.5, less than about 0.25, less than about 0.10, or less than about 0.05 volume percent of components other than an inert gas. Examples of an inert gas include, but are not limited to, nitrogen, argon, and combinations thereof. In some cases, the thermal annealing step can be carried out in an environment including 100 volume percent nitrogen. The at least partially crystalline electrocatalyst can then be withdrawn from the annealing step/zone 60 via line 120 as shown in FIG. 1.

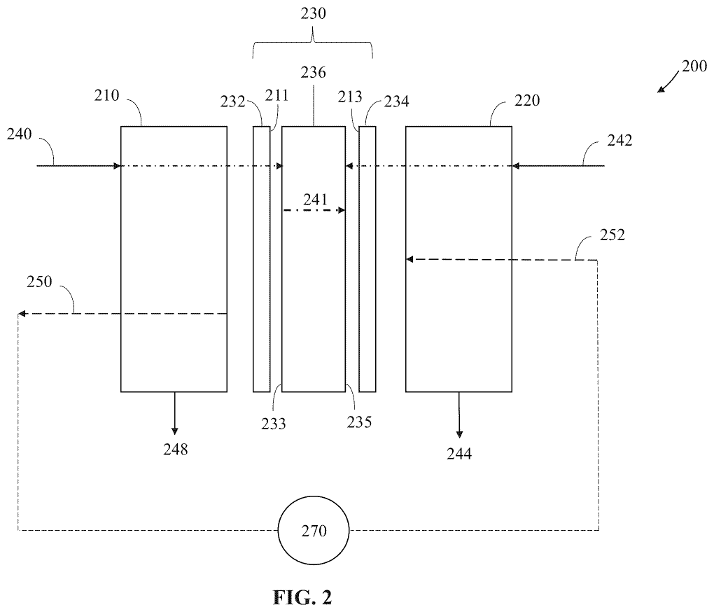

The electrocatalyst described herein can be used in the fabrication of electrodes (e.g., anodes and/or cathodes) for use in fuel cells, especially methanol and hydrogen fuel cells. As used herein, the term “fuel cell” refers to a device for converting chemical energy into electrical energy. Turning now to FIG. 2, a schematic cross-sectional diagram of a generic fuel cell 200 is provided. Fuel cell 200 includes an anode 210, a cathode 220, and an electrolyte assembly 230 disposed between the anode 210 and cathode 220. The electrolyte assembly 230 can include an anode-side gas diffusion layer 234, a cathode-side gas diffusion layer 236, and an electrolyte 236. In some cases, the electrolyte 236 can be a solid electrolyte (such as, for example, a solid polymer), while in other cases, the electrolyte 236 can be a liquid or solution-based electrolyte (such as, for example, an aqueous alkaline solution, an acid, or even molten salt) contained in a membrane or other porous matrix (like a ceramic). In other cases, electrolyte 236 can comprise a membrane, such as a proton exchange membrane or other type of membrane.

In operation, fuel (e.g., hydrogen or a carbon-based material that can be reacted to form hydrogen, such as methanol) can be fed into the anode 210 via line 240 and an oxidant (such as air or enriched oxygen) can be fed into the cathode 220 via line 242. Chemical reactions occur at anode 210 to produce free protons and electrons, which follow different paths through/out of the fuel cell 200. For example, the protons 241 generated during the reaction move across electrolyte 230 and react with the incoming oxygen provided via line 242 at cathode 220. The resulting water can then be removed from the fuel cell via line 244. The electrons produced via the chemical reaction at anode 210 leave via line 250 and are directed as electricity to a load 270. The current from load 270 line 252 returns to the cathode to complete the circuit. Additionally, depending on the exact reaction occurring at the anode 210, other byproducts such as carbon dioxide may also be produced and, if present, may exit the fuel cell 200 via line 248, as generally depicted in FIG. 2.

Fuel cell 200 can be any suitable type of fuel cell and, in some embodiments, can comprise a hydrogen fuel cell or a polymer electrolyte membrane fuel cell (PEMFC). In other embodiments, fuel cell 200 can be a direct methanol fuel cell (DMFC), which is a specialized type of PEMFC that utilizes methanol, rather than hydrogen, as fuel.

Regardless of the type of fuel cell 200, one or both anode 210 and cathode 220 of fuel cell 200 may include a catalyst coated onto (or otherwise disposed on and/or within) at least one surface of one or both electrodes 210, 220 in order to help facilitate the chemical reaction or reactions performed at that electrode or electrodes 210, 220. In some embodiments, both anode 210 and cathode 220 include a catalyst layer or coating (not shown in FIG. 2), while in other embodiments, only one of anode 210 and cathode 220 include a catalyst layer or coating. When both the anode 210 and cathode 220 include a catalyst layer or coating, the catalyst present in the coating can be the same or different at each of the electrodes 210, 220. In some cases, the catalyst used in the layer may actually be coated onto a portion of the electrolyte assembly 230 (such as, for example, on at least one surface of the membrane 236, rather onto a surface of the electrode 210, 220 itself. In other cases, the coating can be applied to a surface of the electrode 210, 220, such as, for example, onto a surface of one or both gas diffusion layers 232, 234.

For example, in some embodiments, the catalyst can be coated onto the anode-side surface 233 and/or the cathode-side surface 235 of the polymer membrane 236, when the fuel cell 200 includes an electrolytic membrane 236. In other embodiments, the catalyst may be coated onto the anode-side gas diffusion layer 232 and/or the cathode-side gas diffusion layer 234. In some cases, catalyst may be coated onto both sides 233, 235 of the membrane 236 and/or on a surface of both gas diffusion layers 232, 234. These coatings, where two or more are present in the fuel cell 200, may include the same type and/or amount of catalyst, or the type and/or amount of catalyst may be different.

The catalyst used in fuel cell 200 can comprise, consist essentially of, or consist of an electrocatalyst according to embodiments of the present technology as described herein. The catalyst may be incorporated into and/or onto the electrode in any suitable manner. For example, in some embodiments, the catalyst may be dispersed in a solvent (such as one or more solvents of the type and amount described previously), along with one or more ionomers. Examples of suitable ionomers include sulfonated tetrafluoroethylene-based ionomers, such as those referred to by the tradename NAFION™ (commercially available from The Chemours Company in Wilmington, DE).

The catalytic dispersion can then be coated onto one or more parts of the fuel cell 200 according to any suitable method, including, but not limited to, spray coating, blade coating, brush coating, dipping, or combinations thereof. The method of applying the catalyst and amount applied depend on the specific portion of the fuel cell 200 to which the catalyst layer or coating is added. In some embodiments, the catalyst layer can have an average thickness of at least about 0.5, at least about 1, at least about 2, at least about 4, at least about 6, at least about 8, at least about 10, at least about 12, at least about 16, at least about 18, or at least about 20 nm and/or not more than about 50, not more than about 45, not more than about 40, not more than about 35, not more than about 30, or not more than about 25 nm. The total catalyst metal loading (measured as weight percent of platinum-group metal, or PGM, with the total catalyst weight as 100 percent) can be at least about 0.5, at least about 0.75, at least about 1, at least about 2, at least about 3, or at least about 3.5 mg PGM per cm² of surface (mg/cm²) and/or not more than about 10, not more than about 8, not more than about 6, not more than about 5, not more than about 3, or not more than about 2 mg/cm².

Once the fuel cell component has been coated with catalyst, it can be dried to form the catalyst layer and the coated element (e.g., membrane or gas diffusion layer) can be hot pressed together with the other elements needed to form the electrolyte assembly 230, which can then be used to construct the entire fuel cell 200 as schematically depicted in FIG. 2.

According to some embodiments, the fuel cell 200 can be a direct methanol fuel cell (DMFC). In such an embodiment, the fuel cell 200 includes a proton exchange membrane 236 as the electrolyte and a pair of gas diffusion layers 232, 234 sandwiching the membrane 236. Anode 210 and cathode 220 may include additional components not shown in FIG. 2 (such as, for example, gaskets between bipolar end plates which receive the reactants (e.g., methanol and oxygen) and which discharge the electricity generated (and receive the return current). In such embodiments, the catalyst may be coated onto one or both surfaces 233 and 235 of membrane 236 to form a catalyst coated membrane 236.

Alternatively, in some embodiments, the catalyst may be coated onto the membrane surface 211 of the anode-side gas diffusion layer 232 and/or the membrane surface 213 of the cathode-side gas diffusion layer 234. Such coated gas diffusion layers can be called gas diffusion electrodes. In some embodiments, the anode-side 233 of the membrane 236 (or the membrane surface 211 of the anode-side gas diffusion layer 232) may comprise a PtRu alloy catalyst formed as described herein, while the cathode-side 235 of the membrane 236 (or the membrane surface 213 of the cathode-side gas diffusion layer 234) may comprise a platinum catalyst including a metal oxide shell coating a carbon-containing support formed as described herein. In some cases, both sides of membrane 236 (or both surfaces of gas diffusion layers 232, 234) can be coated with the same catalyst (e.g., platinum). This may be utilized when, for example, the fuel cell 200 is a hydrogen fuel cell.

In other embodiments, fuel cell 200 can be an anion exchange membrane fuel cell (AEMFC) and the electrochemical catalysts as described herein may be used in a catalyst layer or coating on the anode surface 211 of gas diffusion layer 232 of the fuel cell 200. In such embodiments, the catalyst may be used with an alkaline electrolyte through an anion exchange membrane 236 and may help enhance both the activity and stability of anode for hydrogen oxidation reaction (HOR). In such embodiments, the catalyst may be coated on the surface 213 of the gas diffusion layer 234 in the cathode to enhance the activity and stability of cathode for oxygen reduction reaction (ORR).

### EXAMPLES

### Example 1

Several electrochemical catalysts were prepared according to the following procedure: First, pristine carbon nanotubes (CNTs) (commercially available from Zhongshan CNM Plastic Co., Ltd., in Zhongshan, China) were doped with nitrogen via chemical vapor deposition of pyridine on the cleaned CNTs. The CNTs were placed into a quartz tube and heated from room temperature to a temperature of 760° C. at a rate of 10° C./min under a nitrogen atmosphere. A pyridine solution was then charged into the quartz tube at a rate of 2 mL/h for 4 hours. Then, the furnace was cooled, still under nitrogen, and the nitrogen-doped carbon nanotubes (NCNT) were recovered.

Next, the NCNT was oxygenated by treating 1.0 grams of NCNT in an aqueous mixture formed by combining 2.0 M sulfuric acid and 4.0 M nitric acid (both commercially available from Fischer Scientific of Hamton, New Hampshire). All aqueous solutions mentioned herein were formed with ultrapure water (18.2 mOhm·cm at 25° C.) purified using a water purification system, EASY PURE™ II (commercially available from Thermo Scientific, Waltham, MA), unless otherwise noted. The NCNT/acid mixture was then heated at 120° C. for 12 hours under constant stirring. The resulting oxygenated NCNT (ONCNT) was washed with ultrapure water until the pH reached 7.0 and the solids were then filtered and dried at 80° C. in a vacuum oven.

Some of the ONCNT formed as above were coated with an ultrathin layer of titanium dioxide (TiO₂) according to the following procedure. First, 10.0 mg of ONCNT was dispersed in 6.0 mL of ethanol by ultrasonication for 30 minutes. Next, 10.0 mg of titanium tetraisopropoxide (TTIP; commercially available from Fischer Scientific) was added to this dispersion and sonicated in a water bath. After 30 minutes, the mixture was transferred to a 10-mL Pyrex glass microwave vessel and placed in a microwave synthesizer (Discover® SP commercially available from the CEM Corporation, Matthews, North Carolina). Microwave irradiation at a frequency of 2.45 GHz was applied in dynamic mode with the power up to 300 W to maintain a reaction temperature of 150° C. for 5 minutes. The reaction pressure rose to about 19 bar. After 5 minutes, the product was permitted to cool naturally and the cooled product was washed 2-3 times with ethanol to remove unreacted precursors. The resulting solids were collected by centrifugation and dried at 80° C. in a vacuum oven to provide titanium oxide coated ONCNT (TiO₂/ONCNT).

Next, 16.0 mg of ONCNT was dispersed in 20 mL of a mixture of ethylene glycol and water (in a 4:1 volume ratio) along with 12.5 mg of potassium hexachloroplatinum (K₂PtCl₆) and 5.1 mg of ruthenium chloride (RuCl₃·H₂O) by ultrasonication for 1 hour. The solution was then transferred to a 35-mL Pyrex glass microwave vessel. The weight ratio of 2:1 Pt:Ru is maintained in the precursors of this reaction, and the ethylene glycol serves both as a solvent and a reducing agent in this step. The mixture was then irradiated with microwave energy at a power level of 300 W under the dynamic mode to maintain a reaction temperature of 190° C. for 20 minutes. This reaction deposited platinum and ruthenium nanoparticles (NP) onto the titanium dioxide coating on the carbon support. The reaction pressure rose to 8 bar during this step.

After the reaction, the mixture was cooled and then washed several times with acetone to remove residual ethylene glycol. The solid materials were collected by centrifugation and then dried at 80° C. in a vacuum oven to obtain a catalyst material including titanium dioxide coated ONCNT with plurality of platinum and ruthenium catalytic nanoparticles dispersed on the surface of the titanium dioxide coating (PtRu/TiO₂/ONCNT).

The dried catalyst material was then subjected to an annealing step in a tube furnace at a temperature of 400° C. for 2 hours in an environment of 3% hydrogen and 97% argon at a heating rate of 10° C./min to form crystalline PtRu alloyed nanoparticles and a defective hydrogenated titanium dioxide shell on the ONCNT. The resulting annealed catalyst is referred to herein as Catalyst 1 (PtRu/TiO₂/ONCNT-400).

### Example 2

Additional electrochemical catalysts were prepared using other types of carbon-containing supports in a similar manner as described in Example 1. Specifically, two commercially-available carbon black supports—VULCAN® carbon supports commercially available from Fuel Cell Store in Bryan, Texas and Ketjen black 600JD carbon supports commercially available from HM Royal Materials Distribution in Trenton, New Jersey—were subjected to the same procedure described above with respect to ONCNTs, beginning with the acid treatment step and including annealing at 400° C. for 2 hours as described previously. The resulting catalysts are referred to herein as Catalyst 2 (PtRu/TiO₂/Vulcan-400) and Catalyst 3 (PtRu/TiO₂/KB600JD-400).

### Example 3

Additional electrochemical catalysts were prepared using a carbon support coated with tin (IV) oxide according to the following procedure. Ketjen Black 600JD (KB 600JD) carbon supports (commercially available from HM Royal Materials Distribution in Trenton, New Jersey) were subjected to an acid treatment step as described in Example 1. After being dried at 80° C., 10 mg of the treated carbon was dispersed in 6 mL of ethanol by ultrasonication for 30 minutes. Next, 10 μL of tin isopropoxide (commercially available from Fischer Scientific in Hampton, New Hampshire) was added to the dispersion and sonicated in a water bath. The mixture was then subjected to the same microwave-assisted synthesis step as described in Example 1 to form tin (IV) oxide (SnO₂) coated carbon black. This metal oxide coated support material is referred to herein as SnO₂/C-MW.

A similar SnO₂-coated carbon support was formed in the same manner as described above but including 30 μL of tin isopropoxide to 10 mg of the treated carbon support. The treated carbon support was then exposed to the same microwave-assisted synthesis procedure and the same annealing step. The resulting metal oxide coated support material is referred to herein as h-SnO₂/C-MW.

Next, Pt/Ru catalysts were deposited onto the two SnO₂-coated carbon supports according to the same procedure described in Example 1. Several different annealing steps were performed on the resulting catalysts, as described in detail below.

A portion of the dried catalyst material, which included Pt/Ru on SnO₂-coated carbon supports (Ketjen Black), was subjected to an annealing step as described in Example 1 (i.e., 400° C. for 2 hours in a reducing environment of 3% Hz and 97% Ar). The resulting catalyst is referred to herein as PtRu/SnO₂/C-400 Hz. A portion of the dried high-SnO₂ coated carbon support was also subjected to this annealing step to provide an annealed catalyst material referred to herein as PtRu/h-SnO₂/C-400 Hz.

Additionally, a second portion of the dried high-SnO₂ coated carbon support was subjected to an annealing step carried out in a similar manner as described in Example 1, but in an atmosphere including 100 percent nitrogen (N₂). The resulting catalyst material is referred to herein as PtRu/h-SnO₂/C-400 N₂. A summary of the catalyst materials formed in Examples 1-3 is provided in Table 1, below.

TABLE 1
Summary of Electrochemical Catalysts Prepared & Tested in Examples

| | | | Metal Oxide | | Metal | | Annealing | | |
|---|---|---|---|---|---|---|---|---|---|
| | | Carbon | | Amount, | | Amount, | Temperature, | Time, | |
| Material | Composition | Support | Type | wt % | Type | wt % | ° C. | h | Environment |
| Catalyst 1 | PtRu/TiO₂/ONCNT-400 | ONCNT | TiO₂ | 20.4 | Pt/Ru | 35.7 | 400 | 2 | 3% H₂/Ar |
| Catalyst 2 | PtRu/TiO₂/Vulcan-400 | Vulcan | TiO₂ | 19.2 | Pt/Ru | 27.5 | 400 | 2 | 3% H₂/Ar |
| Catalyst 3 | PtRu/TiO₂/KB600JD-400 | KB | TiO₂ | 19.2 | Pt/Ru | 32.6 | 400 | 2 | 3% H₂/Ar |
| Catalyst 4 | PtRu/SnO₂/C-400 H₂ | KB | SnO₂ | 4.4 | Pt/Ru | 35.7 | 400 | 2 | 3% H₂/Ar |
| Catalyst 5 | PtRu/h-SnO₂/C-400 H₂ | KB | SnO₂ | 9.7 | Pt/Ru | 33.4 | 400 | 2 | 3% H₂/Ar |
| Catalyst 6 | PtRu/h-SnO₂/C-400 N₂ | KB | SnO₂ | 9.7 | Pt/Ru | 37.0 | 400 | 2 | 100% N₂ |
| Control A | TiO₂/ONCNT | ONCNT | TiO₂ | 20.4 | — | — | — | — | — |
| Control B | PtRu/TiO₂/ONCNT | ONCNT | TiO₂ | 20.4 | Pt/Ru | 32.1 | — | — | — |
| Control C | PtRu/ONCNT | ONCNT | — | — | Pt/Ru | 33.3 | — | — | — |
| Control D | PtRu/ONCNT-400 | ONCNT | — | — | Pt/Ru | 34.8 | 400 | 2 | 3% H₂/Ar |
| Comparative 1 | — | C | — | — | Pt/Ru | 73.2 | — | — | — |
| Comparative 2 | — | C | — | — | Pt/Ru | 50 | — | — | — |

### Example 4

The structure of several of the titanium oxide-coated catalyst materials and intermediates described in Examples 1 and 2 and summarized in Table 1 were characterized via transmission electron microscopy (TEM). Three transmission electron microscopes were used, including a Tecnai Osiris Scanning/Transmission Electron Microscope (S/TEM commercially available from FEI in Hillsboro, Oregon) at a 200 kV acceleration voltage, a Hitachi H-8100 TEM (commercially available from Hitachi in Krefeld, Germany) at a 200 kV acceleration voltage, and a Philips CM 100 TEM at a 100 kV acceleration voltage. The crystal structures of the catalysts were examined using a Brucker AXS D8 Advance Discover Diffractometer (commercially available from Brucker Corporation in Karlsruhe, Germany) with a Cu Kα radiation wavelength of 0.15418 nm and a detector slit width of 1 mm.

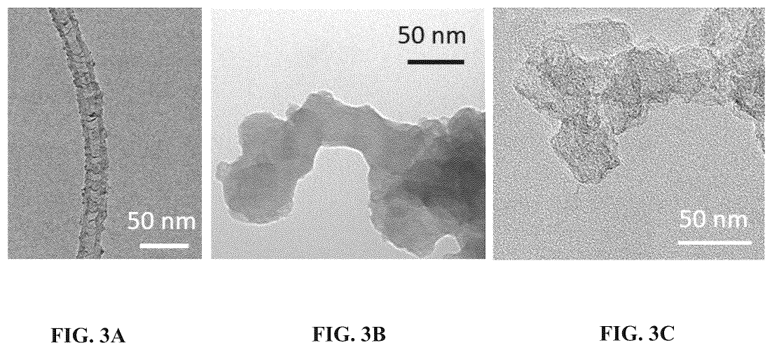

Turning now to FIGS. 3a-c, TEM images of several titanium dioxide coated carbon supports are provided. Specifically, FIG. 3a provides an image of the TiO₂-coated oxygenated, nitrogen-doped CNTs prepared as described in Example 1 (TiO₂/ONCNT). As shown in FIG. 3a, the ONCNTs had a conical stack structure formed from graphitic layers along a fiber axis. The diameter of the cones ranged from 20 to 50 nm and each tube has a length between 2 and 10 microns.

FIGS. 3b and 3c show TEM images of the VULCAN® and Ketjen black (KB) carbon supports coated with TiO₂ as described in Example 2 (TiO₂/Vulcan and TiO₂/KB600JD). Both the VULCAN® and KB supports had a disordered and amorphous structure with irregular shaped carbon particles with an average diameter of between 50 to 80 nm. Each of FIGS. 3a and 3b illustrate the TiO₂ shell formed along at least a portion of the surface of the carbon support. Low contrast difference makes it difficult to observe a clear TiO₂-carbon interface on the TiO₂-coated KB support shown in FIG. 3c, but STEM-EDS elemental mapping was performed on this sample which verified the presence of a TiO₂ shell along the carbon support for this material.

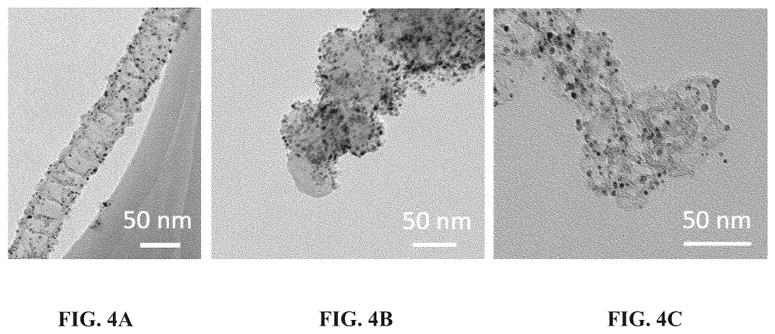

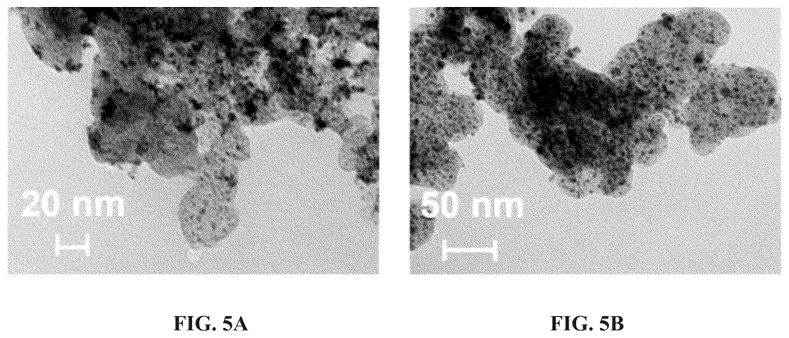

FIGS. 4a-c provide TEM images of several of the annealed catalyst materials prepared as described above. Specifically, FIG. 4a provides a TEM image of the surface of the PtRu/TiO₂/ONCNT-400 catalyst (Catalyst 1) prepared in Example 1, and FIGS. 4b and 4c provide TEM images of the surface of the PtRu/TiO₂/Vulcan-400 (Catalyst 2) and PtRu/TiO₂/KB600JD-400 (Catalyst 3) prepared in Example 2. FIGS. 5a and 5b provide similar TEM images of two commercially available Pt/Ru electrochemical catalysts having a carbon-containing support (PtRu/C designated as Comparative Catalyst I and Comparative Catalyst II). As shown in the TEM images provided in FIGS. 3a and 3b, the Comparative Catalysts I and II have amorphous carbon supports with average diameters between 30 and 50 nm and spherical nanoparticle catalysts. This differs from the fibrous structure of Catalyst 1 (e.g., PtRu/TiO₂/ONCNT-400) as shown in FIG. 4a.

The TEM images provided in FIGS. 4a-c show that the Catalysts 1 to 3 each include uniform and well-separated Pt and Ru nanoparticles on the surface of the TiO₂ coated carbon supports, even after microwave irradiation and thermal annealing. The TiO₂ shell on the ONCNT support of Catalyst 1 shown in FIG. 4a is clearly observed and is slightly less apparent, but still observable, in the Catalysts 2 and 3 shown in FIGS. 4b and 4c.

Further, each of the TiO₂-containing catalysts were subjected to HAADF-STEM elemental mapping of C, O, Ti, Pt, and Ru. The results of these analyses, coupled with the TEM images in FIGS. 4a-c, illustrated that the distribution of TiO₂ over the surface of the carbon supports (e.g., ONCNT, VULCAN®, and KB 600JD) was uniform, and that the Pt and Ru nanoparticles remained intact as particles and were nearly uniformly dispersed over the surface of the catalyst.

High resolution TEM (HRTEM) images of the portion of each catalyst surface designated by the white rectangles shown in FIGS. 4a-c were also taken. The HRTEM images showed lattice fringes of carbon, Ti anatase, and Pt/Ru particles on the surface of the PtRu/TiO₂/ONCNT-400 catalyst (Catalyst 1). This image also confirmed that the crystalline PtRu catalyst nanoparticles are anchored on the surface of the TiO₂ shell that consists of anatase TiO₂ nanocrystals having a size of about 5 to 8 nm in diameter embedded in a continuous amorphous TiO₂ layer or film. Additionally, shell thickness and nanoparticle size for each catalyst were determined. Those results are summarized in Table 2, below.

TABLE 2
Characterization of Select Catalyst Materials

| | | | | Catalytic Nanoparticle | |
|---|---|---|---|---|---|
| | | Metal Oxide Shell | | (PtRu) | |
| | | Shell | TiO₂ | Nanoparticle | Metal |
| | | Thickness, | Content, | Size, | Content, |
| Material | Composition | nm | wt % | nm | wt % |
| Catalyst 1 | PtRu/TiO₂/ONCNT-400 | 5 | 20.4 | 3.8 +/− 0.6 | 35.7 |
| Catalyst 2 | PtRu/TiO₂/Vulcan-400 | 3 to 4 | 19.2 | 3.3 +/− 1.0 | 27.5 |
| Catalyst 3 | PtRu/TiO₂/KB600JD-400 | 3 to 4 | 19.2 | 3.1 +/− 0.6 | 32.6 |
| Control A | PtRu/ONCNT-400 | — | — | 5.4 +/− 1.4 | nd |
| Control B | PtRu/Vulcan-400 | — | — | 6.6 +/− 1.6 | nd |
| Control C | PtRu/KB600JD-400 | — | — | 5.5 +/− 1.4 | nd |
| Comparative I | Commercial PtRu/C | — | — | 4 to 5 | 73.2 |
| Comparative II | Commercial PtRu/C | — | — | 3 to 4 | 50.6 |

nd = not determined

Additionally, similar control catalysts were formed using ONCNT, VULCAN®, and KB 600JD carbon supports, but without a TiO₂ coating layer (designated as Control A, B, and C, respectively). That is, each type of carbon support was treated as described in Example 1, but no TiO₂ coating layer was added. Instead, the Pt and Ru nanoparticles applied directly to the acid-treated carbon support and then annealed at 400° C. for 2 hours in a 3% Hydrogen/97% Argon environment as described in Examples 1 and 2.

Analysis of Controls A-C was also performed as described above in order to determine nanoparticle size. The results of these analyses are summarized in Table 2, above. As shown in Table 2, the particle size of the catalytic nanoparticles applied directly to a treated carbon support (as in Control A to C) was 2 to 3 nm larger than the catalytic nanoparticles applied to a TiO₂ coated carbon support (e.g., Catalysts 1 to 3). This held true for all types of carbon supports (e.g., ONCNT, VULCAN®, and KB). Thus, it can be concluded that the TiO₂ coating had some effect in reducing nanoparticle size and agglomeration during microwave-assisted synthesis and annealing.

Thermogravimetric analysis (TGA) of each of the TiO₂-containing Catalysts 1 to 3 and Comparative Catalysts I and II (which do not include a TiO₂ layer) were performed in air to determine the elemental composition of each catalyst. The TGA was performed using a Thermogravimetric Analyzer (TGA) Q50 system (TA Instruments available from Waters LLC, New Castle, DC) from the room temperature to 900° C. in an air atmosphere. During the TGA measurements, Ru atoms in the nanoparticles were oxidized into RuOₓ (x=1.20) in a temperature range of 400 to 625° C., which leads to a weight increase of about 119%. The weight of the Pt and TiO₂ remained nearly constant for the entire temperature range tested between about room temperature and 900° C. On the basis of these observations and reaction stoichiometry, the weight percent of each component was calculated. Some results of this analysis are provided in Table 2, above.

Additionally, the crystal structure of each of Catalysts 1-3 and Comparative Catalysts I and II was analyzed by X-ray Diffraction (XRD). Diffraction peaks at 2θ angles of 40.2° and 46.72° were observed, confirming the crystalline nature of the Pt catalysts. There was also a peak shift in two of the Pt peaks to higher 2θ angles (as compared to a Pt reference spectrum), thereby signifying formation of a Pt/Ru alloy (rather than only discrete Pt and Ru particles). The shifted peaks were consistent with the XRD patterns of Comparative Catalysts I and II, which both included Pt/Ru alloy particles. The atomic fraction of Pt to Ru was determined to be about 1.6:1 for all of Catalysts 1 to 3 and Comparative Catalysts I and II.

The diffraction peak corresponding to Ru (at a 2θ angle of 44.2°) was observed for all of Catalysts 1 to 3, indicating the presence of some individual Ru nanoparticles along with the Pt/Ru alloy in these materials. However, this Ru peak was not observed for the Comparative Catalysts I and II, meaning that only Pt/Ru alloy particles existed on these catalysts. Additionally, diffraction peaks at a 2θ angle of 25.6° corresponding to anatase TiO₂, indicating the crystalline nature of the TiO₂ shell deposited on the carbon supports for Catalysts 1 to 3. This validates the HTEM images that show TiO₂ anatase nanocrystals embedded in a TiO₂ shell.

### Example 5

The electrochemical performance of several catalysts was determined by performing several experimental trials using a standard three-electrode setup using a CHI 760D electrochemical workstation (commercially available from CH Instruments in Austin, Texas) at room temperature. A silver-silver chloride (Ag/AgCl in 1.0 M KCl) reference electrode and a coiled platinum counter electrode (0.55 mm in diameter and 23 cm in length) were used.

For each trial, the working electrode was prepared by drop-casting the catalyst ink onto a glassy carbon electrode (GCE) encased in a PEEK rod. Before drop-casting the catalyst ink, the GCE was polished using 0.05 micron alumina slurry. Each catalyst ink was prepared by dispersing the required amount of catalyst powder in 1.0 mL of a mixture of ethanol and ultrapure water (at a 3:1 volume ratio) with the addition of 30 microliters of a 5 weight percent perfluorinated resin solution in lower aliphatic alcohols (commercially available as NAFION™ from Sigma Aldrich in St. Louis, Missouri). The platinum group metal catalyst loading was maintained at 54 μg/cm² for all catalysts in the half-cell studies.

Prior to studying the catalytic activity, the catalyst-coated electrodes were subjected to activation by cyclic voltammetry (CV) in the potential range of −0.2 to 0.8 V versus Ag/AgCl (1.0 M KCl) at a sweep rate of 100 mV/s for 50 cycles in argon-purged 0.50 M sulfuric acid electrolyte.

The first set of analyses performed on the catalysts included CO stripping voltammetry experiments. These trials were carried out on each of Catalysts 1 to 3 and Comparative Catalysts I and II in order to evaluate the activity of these catalysts toward CO oxidation. Carbon monoxide (CO) is a strong intermediate which poisons the Pt catalyst during methanol oxidation, so understanding the anti-CO poisoning ability of the catalysts can be useful when evaluating their efficiency in a fuel cell application.

These experiments were performed by first purging the electrolyte (0.5 M sulfuric acid) with argon to remove any dissolved oxygen species and then pure CO gas was purged through the electrolyte for 10 minutes while the potential of the working electrode was maintained at 0.10 V as compared to the reversible hydrogen electrode (RHE). This permitted the formation of a CO monolayer on the Pt surface. After 10 minutes, the purge gas was switched back to pure argon and permitted to purge for 30 minutes to remove the dissolved CO gas from the electrolyte, while the potential of the working electrode was maintained at 0.10 V versus RHE, which retained the adsorbed CO monolayer on the Pt surface. Subsequently, the CO monolayer on the Pt surface was stripped off with a linear anodic sweep at 10 mV/s from 0.10 to 1.222 V (v. RHE). A few CV cycles were taken following CO stripping to evaluate the baseline of the electrode.

Linear CO voltammograms and consequent CV curves were used to evaluate the CO oxidation abilities for each of Catalyst 1 (PtRu/TiO₂/ONCNT-400), Control A (PtRu/ONCNT-400), and Comparative Catalysts I and II. All materials tested showed a clear anodic stripping peak in the first positive scan due to electro-oxidation of the pre-adsorbed CO on the Pt surface. All subsequent CV curves except the Comparative Catalyst I showed only the flat baseline confirming the complete stripping of the adsorbed CO.

The CO oxidation onset potential was determined for all materials tested (Catalyst 1, Control A, and Comparative Catalysts I and II) when the oxidation current reached 0.150 mA/cm²_{geo}. Additional CO stripping voltammetry trials were performed on Catalyst 2 (PtRu/TiO₂/Vulcan) and Catalyst 3 (PtRu/TiO₂/KB600JD). The results are summarized in Table 3, below.

TABLE 3
Results of CO Stripping Tests for Select Catalyst Materials

| | | CO | CO | |
|---|---|---|---|---|
| | | Oxidation | Oxidation | |
| | | Onset | Peak | ECSA |
| Material | Composition | Potential¹ | Potential¹ | m²/g_{Pt} |
| Catalyst 1 | PtRu/TiO₂/ONCNT-400 | 0.170 V | 0.214 V | 67.0 |
| Catalyst 2 | PtRu/TiO₂/Vulcan-400 | 0.394 V | nd² | 98.5 |
| Catalyst 3 | PtRu/TiO₂/KB600JD-400 | 0.319 V | nd² | 133.8 |
| Control A | PtRu/ONCNT-400 | 0.205 V | 0.234 V | 37.6 |
| Comparative | PtRu/C | 0.190 V | 0.228 V | 129.6 |
| I | | | | |
| Comparative | PtRu/C | 0.170 V | 0.302 V | 91.7 |
| II | | | | |

¹Versus an Ag/AgCl (1.0M KCl) reference electrode.
²nd = Not Determined

As shown in Table 3, the TiO₂ shell of Catalyst 1 improves the CO oxidation sufficiently as compared to the same catalyst, but without a TiO₂ shell (Control A). The effect of TiO₂ is observed by comparing the relative CO oxidation onset potentials of Catalyst 1 (with a TiO₂ shell) and Control A (with no TiO₂ shell). As shown in Table 3, the catalyst including a TiO₂ shell (Catalyst 1) has an earlier CO oxidation onset potential than the same catalyst without a TiO₂ shell (Control A).

The electrochemical active surface area (ECSA) of each of the catalysts can be determined by integrating the charge under the CO oxidation curve. More specifically, the ECSA of the Pt in the catalysts was determined using the following equation (1):

$$ECSA = \frac{{Q}_{a}}{{Q}_{CO}^{0} \times {m}_{Pt}}$$

where Qₐ (μC/cm²) is the charge associated with the integrated area of CO oxidation peak; Q_{co}⁰=420 μC/cm² is the charge required to oxidize a monolayer of CO adsorbed on 1 cm² of flat Pt surface, and m_{Pt} (g_{Pt}/cm²) is the mass loading of Pt on the working electrode surface. Catalysts with low CO oxidation potential and high ECSA are the most desired for best performance in methanol oxidation reactions (MOR). The results of these calculations for Catalysts 1 to 3, Control A, and Comparative Catalysts I and II are provided in Table 3, above.

As shown in Table 3, the ECSA of Catalyst 1 (with TiO₂ shell) is higher than Control A (same catalyst but without TiO₂ shell), indicating that the presence of the TiO₂ shell helps facilitate better dispersion of the catalytic nanoparticles (Pt and Ru).

### Example 6

Several catalysts, including Catalyst 1 (PtRu/TiO₂/ONCNT-400), Control A (PtRu/ONCNT-400), and the commercially-available Comparative Catalysts I and II, were further analyzed to determine their electrocatalytic performance in methanol oxidation reaction (MOR). The procedure used, as well as results and analysis, are provided below.

Catalytic performance was determined by cyclic voltammetry (CV) in argon-saturated 0.50 M sulfuric acid with a 0.75 M methanol solution having a platinum group metal (PGM) catalyst loading of 54 μg/cm². A typical CV curve of MOR consists of two irreversible oxidation peaks, one in the forward anodic scan and the other in the backward cathodic scan. The forward peak current density (I_{f}) is attributed to the methanol oxidation on the Pt surface whereas the backward peak current density (I_{b}) is commonly attributed to the oxidation of carbonaceous intermediate species formed in the previous anodic scan. Thus, the I_{f}/I_{b} ratio is associated with the degree of oxophilicity of the catalyst.

MOR curves were generated from the 100^{th} CV cycle for each of Catalyst 1 (PtRu/TiO₂/ONCNT-400) and Control A (PtRu/ONCNT-400), as well as both commercial samples Control I and II. Catalyst 1 exhibited the highest I_{f} (18.61 mA/cm²_{geo}), thereby outperforming not only Control A (10.90 mA/cm²_{geo}) but also commercial Comparative Catalyst I (17.20 mA/cm²_{geo}) and Comparative Catalyst II (15.91 mA/cm²_{geo}). Additionally, unannealed samples of Control A (PtRu/ONCNT) and Catalyst 1 (PtRu/TiO₂/ONCNT) were also run to determine MOR activity, and the values of all four are summarized below in Table 4.

TABLE 4
Electrochemical Performance of Select Catalyst Materials

| | | I_{f}, mA/cm²_{geo} | | |
|---|---|---|---|---|
| Material | Composition | Unannealed | Annealed | I_{f}/I_{b} |
| Catalyst 1 | PtRu/TiO₂/ONCNT | 18.5 | 18.6 | 1.1 |
| Control A | PtRu/ONCNT | 16.6 | 10.9 | nd |
| Control B | PtRu/TiO₂/Vulcan | — | 17.8 | 1.3 |
| Control C | PtRu/TiO₂/KB600JD | — | 18.1 | 2.98 |

| | | | |
|---|---|---|---|
| Comparative I | Commercial PtRu/C | 13.1 | 1.54 |
| Comparative II | Commercial PtRu/C | 12.2 | 3.57 |

nd = not determined
All I_{f}/I_{b} are for annealed catalyst, except Comparative I and II, which were measured as received.

As shown in Table 4 above, the difference between the annealed and unannealed samples of Control A (no TiO₂ shell) was much greater than the difference between the annealed and unannealed samples of Catalyst 1 (TiO₂ shell). This is mainly due to the due to agglomeration of the catalytic metals that occurs when the metals were annealed without the presence of a hydrogenated TiO₂ shell.

Further, the unannealed Catalyst 1 had an I_{f}/I_{b} ratio of 0.9, which is significantly less than the 1.1 ratio of the annealed version. Although the difference in I_{f} between the annealed and unannealed Catalyst 1 was small, the difference in the I_{f}/I_{b} between these two was much larger. This further supports the conclusion that thermal annealing helps enhance the oxophilicity of the catalyst.

The mass activity and ECSA-normalized specific activity of each of Catalyst 1, Control A, and the Comparative Catalysts I and II were also determined. Mass activity is defined by the measured geometric current density I_{f} (mA/cm²) divided by the mass loading of Pt (mg_{Pt}/cm²), and the ECSA-normalized specific activity is defined by I_{f} (mA/cm²) divided by the product of ECSA (m²/g_{Pt}) and Pt loading (mg_{Pt}/cm²) on the electrode surface. The results are shown in Table 5, below.

TABLE 5
MOR Catalytic Activity Analysis for Select Catalyst Materials

| | | | ESCA- | |
|---|---|---|---|---|
| | | | Normalized | |
| | | Mass | Specific | Drop in I_{f} |
| | | Activity, | Activity | over 500 CV |
| Material | Composition | mA/mg_{Pt} | mA/cm² ESCA | cycles, % |
| Catalyst 1 | PtRu/TiO₂/ | 511.6 | 0.76 | 3.6 |
| | ONCNT-400 | | | |
| Control A | PtRu/ | 300.3 | >0.76 | 6.8 |
| | ONCNT-400 | | | |
| Comparative | Commercial | 472.6 | 0.51 | 20.7 |
| I | PtRu/C | | | |
| Comparative | Commercial | 438.1 | 0.44 | 12.5 |
| II | PtRu/C | | | |

As shown in Table 5, above, Catalyst 1 had a higher mass activity and ESCA-normalized specific activity than either of the commercial catalysts. Although the Control A (no TiO₂ shell) had a higher ESCA-normalized specific activity, it had a much lower mass activity. In light of all factors, Catalyst 1 exhibited the highest MOR catalytic activity.

Additionally, the long-term stability of each of the above catalysts was also evaluated by monitoring the I_{f}/I_{b} ratio and If values over 500 consecutive CV cycles. All catalyst materials tested showed a rapid decrease in I_{f}/I_{b} ratio in the initial 25 cycles, but became stabilized after the 25^{th} cycle with each material retaining nearly the same oxophilicity from the 25^{th} to 500^{th} cycle. The If values of the two Comparative Catalysts I and II dropped by 20.7% and 12.5%, respectively, over 500 cycles, while the If of Catalyst 1 and Control A actually increased for the first 100 to 200 cycles. Thereafter, the If of these two materials dropped 3.6% and 6.8% from the highest point over the last cycles (up to 500), indicating significantly higher long-term stability than the commercial samples Comparative Catalysts I and II.

### Example 7

Several catalysts were tested for performance as anode catalysts for a direct methanol fuel cell (DMFC) at various methanol concentrations. First, both the anode and cathode were spray-coated on to Toray H060 gas diffusion layer (GDL) at an ionomer to carbon ratio of 1.0 and 0.2, respectively. The platinum group metal (PGM) loading of the anode and cathode were maintained at 4.5 mg/cm² and 1.5 mg/cm², respectively. A NAFION™ 212 membrane with 50 μm thickness was used in this study. The anode and cathode GDEs were sandwiched between the NAFION™ 212 membrane and hot-pressed at 275° F. for five minutes to form a membrane electrode assembly (MEA). The DMFC was then fed with various concentrations of methanol feed as fuel at a flow rate of 0.5 mL/min at the anode and oxygen or air as fuel at 0.1 L/min at the cathode. The DMFC stack temperature was maintained at 80° C., 90° C., and 100° C. Performance increases with increasing temperature owing to the enhanced kinetics of the reaction at higher temperatures.

TABLE 6
DMFC Performance Data for Select Catalyst Materials

| | | Open Circuit | | Peak Power Density, | |
|---|---|---|---|---|---|
| | | Voltage, V | | mW/cm² | |
| Material | Composition | 1.0M¹ | 3.0M¹ | 1.0M¹ | 3.0M¹ |
| Catalyst 1 | PtRu/TiO₂/ | 0.57 | 0.35 | 27.2 | 13.14 |
| | ONCNT-400 | | | | |
| Catalyst 3 | PtRu/TiO₂/ | 0.58 | 0.45 | 63.3 | 31.2 |
| | KB600JD-400 | | | | |
| Comparative | Commercial | 0.6 | 0.53 | 68.1 | 21.6 |
| II | PtRu/C | | | | |

¹Methanol Concentration

As shown in Table 6 above, both the membrane electrode assemblies (MEA) with Catalyst 1 and Catalyst 3 showed about a 50 percent drop in performance with increased methanol concentration. However, as also shown in Table 6, an increase in methanol concentration from 1.0 to 3.0 M caused a 70 percent reduction in performance of the commercial catalyst tested (Comparative II).

### Example 8

The structure of several of the catalyst materials and intermediates including a tin oxide coating layer described in Example 3 and summarized in Table 1 were characterized as described in Example 4.

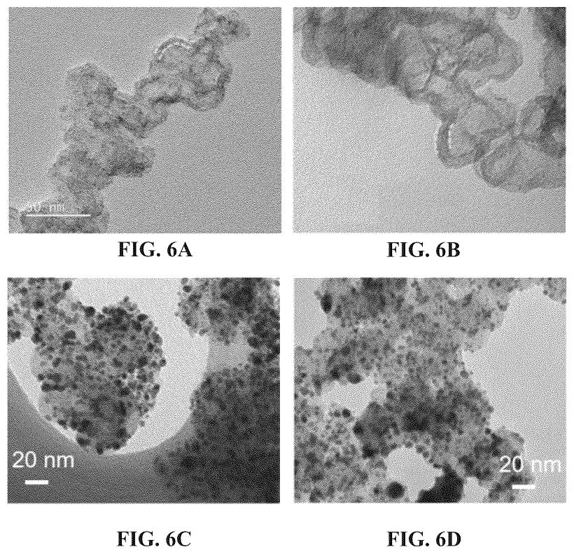

Turning now to FIGS. 6a-d, TEM images of several materials and catalysts having tin oxide-coated carbon supports formed as described in Example 3 are provided. Specifically, FIGS. 6a and 6c provide images of the SnO₂-coated supports (SnO₂/C) before (FIG. 6a) and after (FIG. 6c) deposition of the catalytic nanoparticles of Pt and Ru. Similarly, FIGS. 6b and 6d provide similar before (FIG. 6b) and after (FIG. 6d) images of catalysts including higher amounts (˜9.7%) of tin oxide (h-SiO₂/C). The catalysts shown in FIGS. 6c and 6d have been annealed as described in Example 3 and shown in Table 7, below.

Thermogravimetric analysis (TGA) of each of the SnO₂-containing Catalysts 4 to 6 was performed in air in a similar manner as done with the TiO₂ containing catalysts in Example 4. Based on the TEM images and a TGA analysis of these materials performed in a manner similar to that described in Example 4, tin oxide shell thickness and Pt/Ru nanoparticle size, as well as metal and metal oxide (SnO₂) contents, were determined for each catalyst. The results are summarized in Table 7, below.

TABLE 7
Characterization of Select Catalyst Materials

| | | | | Catalytic Nanoparticle | |
|---|---|---|---|---|---|
| | | Metal Oxide Shell | | (PtRu) | |
| | | Shell | SnO₂ | Nanoparticle | Metal |
| | | Thickness, | Content, | Size, | Content, |
| Material | Composition | nm | wt % | nm | wt % |
| Catalyst 4 | PtRu/SnO₂/C-400 H₂ | 6 to 7 | 4.4 | 5.4 +/− 1.2 | 35.7 |
| Catalyst 5 | PtRu/h-SnO₂/C-400 H₂ | 8 to 9 | 9.7 | 4.3 +/− 1.4 | 33.4 |
| Catalyst 6 | PtRu/h-SnO₂/C-400 N₂ | 8 to 9 | 9.7 | nd | 37.0 |
| Comparative I | Commercial PtRu/C | — | — | 3 to 4 | 73.2 |
| Comparative II | Commercial PtRu/C | — | — | 4 to 5 | 50.6 |
| Comparative III | Commercial PtRu/C | | | 3 to 4 | 77 |

nd = not determined

As shown in Table 7, above, an increase in tin oxide content in the catalyst shell (and resultant increase in shell thickness) results in smaller nanoparticle size after annealing. It is believed that the additional SnO₂ helps mitigate metal agglomeration during annealing, likely due to stronger metal-support interactions. As a result, catalysts coated with higher amounts of tin oxide have smaller metal nanoparticles.

### Example 9

Several CO stripping voltammetry experiments as described in Example 5 were performed on tin oxide coated catalysts. In addition, new samples of Comparative Catalysts I to III, which are all PtRu catalytic nanoparticles on carbon supports, were also tested. The results of the CO stripping experiments for these materials are summarized in Table 8, below.

TABLE 8
Results of CO Stripping Tests for Select Catalyst Materials

| | | CO Oxidation | |
|---|---|---|---|
| | | Onset | ECSA, |
| Material | Catalyst | Potential¹, V | m²/g_{Pt} |
| Catalyst 4 | PtRu/SnO₂/C-400 H₂ | 0.283 | 78.9 |
| Catalyst 5 | PtRu/h-SnO₂/C-400 H₂ | 0.263 | 87.4 |
| Catalyst 6 | PtRu/h-SnO₂/C-400 N₂ | 0.194 | 76.4 |
| Comparative I | Commercial PtRu/C | 0.435 | 91.7 |
| Comparative II | Commercial PtRu/C | 0.415 | 99.5 |
| Comparative III | Commercial PtRu/C | 0.415 | 82.7 |

As shown in Table 8, the tin coated catalysts prepared according to embodiments of the present technology had a lower oxidation onset potential than any of the comparative catalysts by around 50 percent. The ECSAs of Catalysts 4 to 6 were slightly lower than the Comparative Catalysts I to III. Additionally, the tin oxide coated catalyst annealed in nitrogen had a significantly lower CO oxidation onset potential, but similar ECSA to the tin oxide coated catalysts annealed in the 3% hydrogen/97% argon environment.

### Example 10

Several catalysts, including tin oxide coated Catalysts 4 to 6 and Comparative Catalysts I to III, were tested for catalytic activity for MOR in a similar manner as described in Example 6 previously with respect to TiO₂ coated catalysts. The results of these tests are summarized in Table 9, below.

TABLE 9
MOR Catalytic Activity Results for Select Catalyst Materials

| | | I_{f}, | MOR Onset |
|---|---|---|---|
| Sample | Catalyst | mA/cm²_{geo} | Potential, V |
| Catalyst 4 | PtRu/SnO₂/C-400 H₂ | 10.7 | 0.472 |
| Catalyst 5 | PtRu/h-SnO₂/C-400 H₂ | 12.6 | 0.437 |
| Catalyst 6 | PtRu/h-SnO₂/C-400 N₂ | >12.6 | nd |
| Comparative I | Commercial PtRu/C | 13.1 | 0.50 |
| Comparative II | Commercial PtRu/C | 12.2 | 0.465 |
| Comparative III | Commercial PtRu/C | 12.8 | 0.556 |

### Definitions

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. An electrochemical catalyst suitable for use in fuel cell applications, the catalyst comprising:
a carbon-containing support;
a transition metal oxide shell coated onto at least a surface of the carbon-containing support; and
a plurality of discrete catalytic nanoparticles disposed in and/or on at least a portion of the transition metal oxide shell.

2. The catalyst of claim 1, wherein the catalytic nanoparticles comprise platinum and ruthenium (Pt/Ru) alloy nanoparticles.

3. The catalyst of claim 2, wherein the catalytic nanoparticles further comprise ruthenium (Ru) nanoparticles.

4. The catalyst of claim 1, wherein the catalytic nanoparticles have an average diameter of at least about 0.5 nm and/or not more than 6 nm.

5. The catalyst of claim 1, wherein the transition metal oxide shell has an average thickness of at least about 1 nm and/or not more than 15 nm.

6. The catalyst of claim 1, wherein the transition metal oxide shell comprises one or more metal oxides selected from the group consisting of titanium dioxide (TiO₂), tin (IV) oxide (SnO₂), ruthenium oxide (RuO₂), cerium oxide (CeO₂), and wherein at least a portion of the transition metal oxide shell comprises both amorphous and crystalline transition metal oxide.

7. The catalyst of claim 1, wherein at least a portion of the transition metal oxide shell comprises a hydrogenated transition metal oxide and wherein the carbon-containing support comprises an oxygenated carbon-containing support.

8. The catalyst of claim 1, wherein the carbon-containing support comprises oxygen-functionalized, nitrogen-doped carbon nanotubes (ONCNT) having a shape resembling a plurality of cones stacked together to form fibers, wherein the fibers have an average diameter in the range of from 10 nm to 1 micron and an average length in the range of from 0.5 to 20 microns.

9. The catalyst of claim 1, wherein the carbon-containing support comprises graphene or an amorphous carbon black.

10. A method of making an electrochemical catalyst suitable for use in a fuel cell, the method comprising:
(a) forming a first reaction mixture comprising a carbon-containing support material, a metal oxide or precursor thereto, and a first solvent; and
(b) heating the first reaction mixture to a temperature of not more than about 300° C. to form transition metal oxide coated carbon-containing support particles;
(c) forming a second reaction mixture comprising the transition metal oxide coated carbon-containing support particles, at least one catalytic metal or precursor thereto, and a second solvent; and
(d) heating the second reaction mixture to a temperature of at least 100° C. to provide particles of an electrochemical catalyst.

11. The method of claim 10, wherein at least 80 percent of the total energy used to perform the heating of step (b) is microwave energy and wherein the heating of step (b) is carried out for a period of time in the range of from 1 minute to 15 minutes and the first reaction mixture is heated to a temperature of less than 165° C.

12. The method of claim 11, wherein at least 80 percent of the total energy used to perform the heating of step (d) is microwave energy and wherein the heating of step (d) is carried out for a period of time in the range of from 1 minute to 15 minutes and the second reaction mixture is heated to a temperature of at least 185° C.

13. The method of claim 10, further comprising subsequent to the heating of step (d) annealing at least a portion of the electrochemical catalyst at a temperature in the range of from about 300° C. to about 600° C. to provide an annealed electrochemical catalyst.

14. The method of claim 10, wherein the annealing is carried out in an atmosphere comprising hydrogen in an amount of at least 0.5 volume percent and/or not more than 6 volume percent.

15. The method of claim 10, wherein the process is a pilot-plant or commercial scale process providing at least 50 pounds per hour (lb/h) of electrochemical catalyst, averaged over a 30 day period.

16. A fuel cell comprising:
an anode;
a cathode; and
at least one fuel cell electrolyte disposed between the anode and the cathode,
wherein at least one of the anode, the cathode, and the electrolyte presents a first surface at least partially coated with a first catalyst layer, wherein the first catalyst layer comprises electrochemical catalyst particles comprising a carbon-containing support at least partially coated by a transition metal oxide layer and a plurality of discrete catalytic nanoparticles disposed in and/or on the metal oxide layer.

17. The fuel cell of claim 16, wherein the fuel cell is a hydrogen fuel cell and the catalytic nanoparticles comprise predominantly platinum nanoparticles.

18. The fuel cell of claim 16, wherein the fuel cell is a polymer electrolyte membrane fuel cell (PEMFC) and wherein the electrolyte comprises at least one membrane having a cathode surface positioned nearest the cathode and an anode surface positioned nearest the anode.

19. The fuel cell of claim 18, wherein the first surface is the cathode surface of the membrane and wherein the catalytic nanoparticles comprise predominantly platinum nanoparticles.

20. The fuel cell of claim 18, wherein the first surface is the anode surface of the membrane and wherein the catalytic nanoparticles comprise predominantly platinum-ruthenium alloy nanoparticles.
